(19) United States
(12) Patent Application Publication
(10) Pub. No.: US 2006/0018582 A1
(43) Pub. Date: Jan. 26, 2006

(54) Bearing having thermal compensating capability

(76) Inventors: Mircea Gradu, Wooster, OH (US); Russell F. Folger, Canton, OH (US); David D. Crichton, Louisville, OH (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/899,348

(22) Filed: Jul. 26, 2004

(51) Int. Cl. F16C 19/24; F16H 37/08

(52) U.S. Cl. 384/557

(57) ABSTRACT

A tapered roller bearing for use in transmission cases made from aluminum alloy or other lightweight materials where the transmission contains a steel shaft which is supported in the case on two directly mounted tapered roller bearings, so that the two bearings confine the shaft both radially and axially. To compensate for the differences in expansion and contraction between the aluminum case and the steel shaft as the transmission or transaxle experiences variations in temperature, a race of at least one of the bearings is fitted with a compensating ring having a coefficient of thermal expansion greater than that of the case or shaft. As a consequence, the bearings operate at a generally uniform setting over a wide range of temperature variations.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates in general to bearings and more particularly to a bearing having the ability to compensate for differential thermal expansion and contraction between a structure in which the bearing is mounted and a shaft located within the bearing.

In an effort to reduce weight, the cases for various mechanical transmission devices are being constructed from lightweight material such as aluminum alloys. However, the shafts which turn in these cases and carry the gears that transmit the torque remain of steel, obviously because steel has great strength and resists wear.

A variety of bearing arrangements exist for mounting shafts in transmission and transaxle cases, but the most compact and durable utilize tapered roller bearings. In a typical in-line transmission device, the input and output shafts are axially aligned and are confined at opposite ends of the case in two single row tapered roller bearings which, with respect to each other, are directly mounted, that is the large ends of the rollers for each bearing are presented inwardly toward the interior of the case and toward each other. Moreover, the input shaft has a pocket which receives the end of the output shaft, and here the output shaft is provided with another single row tapered roller bearing, known as a pocket bearing, which is also mounted directly with respect to the bearing for the output shaft. The tapered roller bearings in these applications carry extremely heavy loads for their size. Furthermore, they take axial or thrust loads as well as radial loads, and thus, a minimum number of bearings accommodate all of the loads to which the shafts are subjected.

Ideally, opposed tapered roller bearings should operate within an optimum setting range dictated by application requirements. Generally speaking, the objective is to minimize axial and radial free motion in the shafts, for this maximizes the bearing life, reduces noise, and improves gear mesh. The directly mounted bearings which support the aligned input and output shafts in effect capture those shafts axially.

If the transmission device case were made from steel, like the shafts and bearings, the case and shafts and the bearings would expand similarly with temperature variations, and the settings of the bearings for each shaft would not change drastically over a wide range of temperatures. However, the aluminum alloys from which many cases for the transmission devices are currently manufactured, have coefficients of thermal expansion greater than that of the steel from which the shafts and bearings are made. Assuming such a transmission device is assembled at room temperature with its directly mounted bearings in a condition of zero end play, the bearings will experience preload when the temperature drops, because the case contracts more than the shafts. By the same token, the bearings will experience end play as the temperature rises above room temperature, since the case expands more than the shafts. While the expansion and contraction of the tapered roller bearings, due to the geometry of the bearings, tends to offset some of the effects of the differential expansion and contraction between the case and shafts, it is not enough to maintain bearing settings generally constant over a wide range of temperature.

Excessive preload into the bearings at assembly can compensate for some of the looseness caused by the case expansion, however, this increases the amount of friction in the internal components and subsequently increase the amount of wear on the internal components. Additionally, the effort rotate gears on the shafts will increase during cold start up of the transmission device. when On the other hand, when the transmission device is heated, excessive end play decreases the size of the zones through which loads are transmitted in the bearings resulting in spaces and gaps between the components of the bearings thereby reducing the life of the bearings. Since end play allows some radial and axial displacement of the shafts, it may also change the positions in which the gears of a transmission device mesh.

U.S. Pat. No. 5,028,152 discloses a machine with thermally compensating bearings and is incorporated herein by reference. In that device, the bearings require a specially machined bearing cup that includes creating a rabbet in the face of the bearing. An elastometric compensating ring is placed within the rabbet and acts to compensate for differences in thermal expansion of the bearing having steel components and a machine having lightweight aluminum casing. However, the rabbet design of the bearing in that patent requires the bearing cup to be specially machined thereby adding increased cost to the bearing and increases the difficulty of assembling the bearing.

The bearing of present invention is a tapered roller bearing that requires little if any machining of the bearing cup. Instead, the thermal compensation components can be positioned against the back face of the bearing in the manner of an add-on accessory to the bearing. This results in a lower cost bearing that is less complex to assemble and which allows for the possibility of adding thermal compensating components to existing bearings or incorporating thermal compensating components to a bearing with less effort.

Additionally, the present invention may be mounted at the ends of the shafts of a transmission having a case made from an aluminum alloy or other light weight material having a thermal coefficient of expansion greater than the steel used to manufacture the bearings and the shafts. The unique design of the bearing has the capability to compensate for differential thermal expansion and contraction between the case, and the bearings and shaft within the case. As a result, the bearings remain at a more uniform setting over a wider range of operating temperatures.

Additional features of the present invention will be in part apparent and in part pointed out hereinafter.

### BRIEF DESCRIPTION OF THE SEVERAL VIEWS OF THE DRAWINGS

In the accompanying drawings which form part of the specification and wherein like numerals and letters refer to like parts wherever they occur:

FIG. 1 is a sectional view of one embodiment of the present invention as mounted would be mounted in a transmission device.

FIG. 2 is a sectional view of one embodiment of the bearing of the present invention showing a tapered roller bearing having thermally compensating components.

FIG. 3 is a sectional view of a second embodiment of the bearing of the present invention showing a tapered roller bearing having thermally compensating components.

FIG. 4 is a sectional view of a third embodiment of the bearing of the present invention showing a tapered roller bearing having thermally compensating components.

While three embodiments of the present invention are illustrated in the above referenced drawings and in the following description, it is understood that the embodiments shown are merely for purpose of illustration and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION

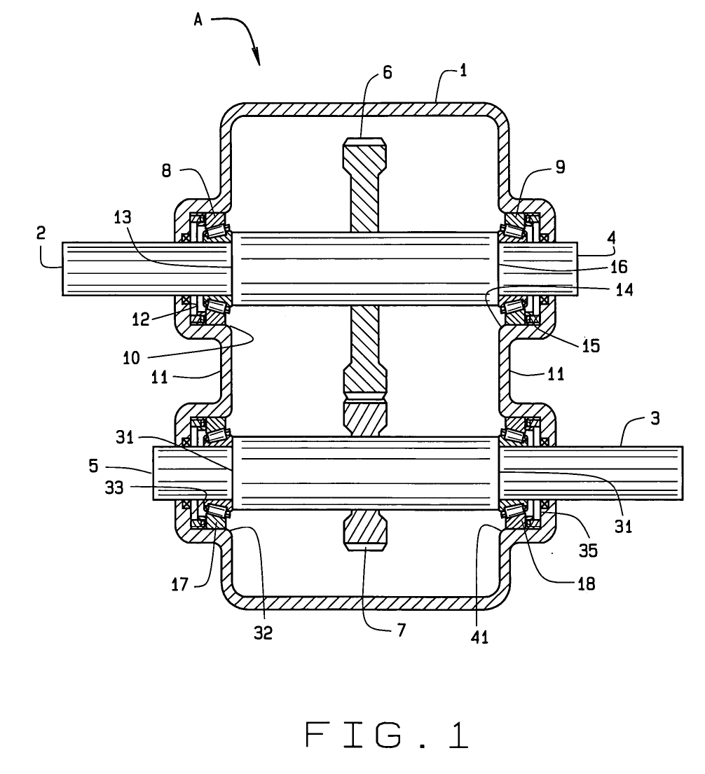

Referring now to the drawings, one embodiment of the present invention is shown that includes a transmission device A (FIG. 1) having a case 1 that is cast from a lightweight metal such as aluminum alloy. The transmission device A also has an input shaft 2 and an output shaft 3, with each of the two shafts 2 and 3 having an end 4 and 5 respectively. The shafts 2 and 3 carry gears 6 and 7, which mesh in different combinations to produce different speed ratios between the input shaft 2 and the output shaft 3. The shafts 2 and 3 are machined from steel, as are the gears 6 and 7 on them.

The input shaft 2 rotates in two single row tapered roller bearings 8 and 9 that fit around it and within a bore 10 in the wall 11 at each end of the case 1, the bearings 8 and 9 being located between abutments: that is, a shoulder 12 at the end of the bore 10 and another shoulder 13 on the shaft 2. The end 4 of the input shaft 2 rotates on another single row tapered roller bearing 9 located in a bore 14 at the opposite end wall of the case 1. It is also located between abutments in the form of a shoulder 15 at the end of the bore 14 and a backing face 16 on the shaft 2. The output shaft 3 rotates in a similar manner between bearings 17 and 18 in the walls of the case 1.

Each of the bearings 8, 9, 17, and 18 has an axis X of rotation which lies coincident with the axis X of the shaft 2 or 3 which it supports, and being a single row tapered roller bearing, it includes (FIG. 1) a cone 19 which fits around one of the shafts 2 or 3, a cup 20 which fits into one of the bores 10 or 14 and around the cone 19, tapered rollers 21 which are arranged in a single row between the cone 19 and cup 20, and a cage 22 for maintaining the proper spacing between the rollers 21. The cup 20 remains essentially stationary in the case 1, while the cone 19 rotates within the case 1 as its particular shaft 2 or 3 turns about its axis X of rotation.

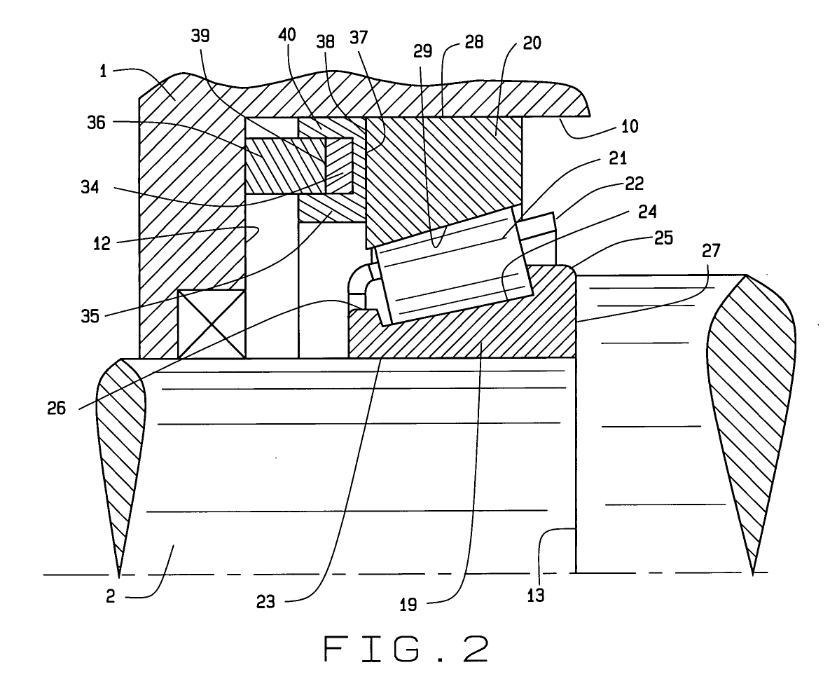

The cone 19 has a bore 23 (FIG. 2), which is slightly smaller than the shaft 2 or 3 over which the cone 19 fits, so that an interference fit exists between the cone 19 and its shaft. It also has a tapered raceway 24, which is presented, outwardly toward the cup 20. The raceway 24 lies between a thrust rib 25 and a retaining rib 26, both of which project outwardly beyond the raceway 24. The two ends of the cone 19 are squared off with respect to the axis X of rotation, the end at the thrust rib 25 forming a cone back face 27.

The cup 20 has an outwardly presented cylindrical surface 28 which may be slightly smaller or slightly larger than the bore 10 or 14 into which it fits, depending on whether an interference or loose fit is desired. In addition, the cup 20 has a tapered raceway 29, which is presented inwardly toward the tapered raceway 24 of the cone 19. The ends of the cup 20 are squared off with respect to the axis X, the larger of the end faces, which is at the small end of the tapered raceway 29, forming a cup back face 30.

The tapered rollers 21 lie in a single circumferential row between the raceways 24 and 29 of the cone 19 and cup 20 with their large end face presented toward the thrust rib 25 of the cone 19. The thrust rib 25 prevents the rollers 21 from being expelled from the space between the two raceways 24 and 29 when a radial load is transmitted through the rollers 21. Moreover, the rollers 21 are on apex, meaning that if the side faces of the rollers 21 were extended to their respective apexes, those apexes would lie at a common point along the axis X, and the same holds true with regard to the two raceways 24 and 29.

The taper of the cone raceway 24 and the cup raceway 29, together with the taper of the rollers 21 which fit between them, enables the bearings 8, 9, 17, and 18 (FIG. 1) to transmit radial loads and axial loads, with the latter being resisted by shoulders 12 and 15 at the ends of the bores 10 and 14 and by the shoulders 13 and 16 on the shafts 2 and 3. In this regard, the cone 19 (FIG. 2) of the bearing 8 fits tightly around the input shaft 3 with its back face 27 against the shoulder 13. The cup 20 of that bearing fits snugly in the bore 10. While the cone 19 for the other bearing 9 (FIG. 2) fits snugly around the input shaft 2, the cup 19 (FIG. 1) of that bearing fits loosely in the bore 14 with its back face presented toward, but not contacting, the shoulder 15 at the end of the bore 14. Similarly, the cones of the two bearings 17 and 18 for the output shaft 3 fit snugly around the output shaft 3 with their back faces against the shoulders 31 on the output shaft 3. The cup of the bearing 17 fits snugly within its bore 32 where its back face is against the shoulder 33 at the end of the bore 32. On the other hand, the cup of the bearing 18 fits loosely into the bore 41, and while its back face is presented toward the shoulder 35 at the end of that bore, it does not actually contact the shoulder 35. The cage 22 of each bearing 8, 9, 17, and 18 maintains a slight separation between adjacent rollers 21. It further holds the rollers 21 around the cone raceway 24 when the cone 19 is removed from the cup 20. The bearings 8 and 9 of the input shaft 2, and the bearings 17, and 18 of the output shaft 3 are located along the common axis X of the input and output shafts 2 and 3, and operate at a common setting. That common setting depends on the location of the cups 19 (FIG. 2) for the two bearings 8 and 9, or 17 and 18, that are in the transmission device case 1—or at least is controlled by the location of those cups 20. For example, if the cups 20 are spread too far apart, the shafts 2 and 3 will be loose between the cups 20, or in other words, will be in a condition of end play. On the other hand, if the cups 20 are too close together, the bearings 8 and 9, or 17 and 18, and those portions of the shafts 2 and 3 that are between them, will be in a state of compression, or in other words, in a condition of preload.

When subjected to temperature variations, the case 1, being formed from an aluminum alloy having a high thermal coefficient of expansion, undergoes greater dimensional changes than the shafts 2 and 3, which are formed from steel. In fact, aluminum alloy has about twice the coefficient of thermal expansion as does steel. Thus, an elevation in temperature of the entire transmission device A will cause the end walls of the case 1 to spread farther apart and they of course will carry the shoulders 12 & 15, and 33 & 35, that locate the cups 20 of the bearings 8, 9, 17, and 18, outwardly with them. The shafts 2 and 3 will also grow and this spreads the backing shoulders 13, 16, and 31 on the aligned shafts 2 and 3 farther apart. But, due to the substantial difference in the thermal coefficient of expansion between aluminum alloy and steel, the increase in distance between the shoulders 12 and 15 of the bores 10 and 14 can be about twice as great as the increase in the distance between the backing shoulders 13, 16, and 31 on the shafts 2 and 3. This differential expansion could significantly alter the setting of the bearings 8, 9, 17, and 18 were it not for a compensating ring 34 (FIG. 2) of the present invention.

More specifically, in the present embodiment, an annular U-shaped support ring 35 is located at the front face 30 of the cup 20, such that the bottom surface 37 of the annular U-shaped support ring 35 is against the back face 38 of the cup 20. In the present embodiment, the annular U-shaped support ring 35 is made from steel and is annular with respect to the axis X. The compensating ring 34 is generally rectangular in shape and is positioned inside the annular U-shaped support ring 35, the top surface 39 of the compensating ring 34 being between the flanges 40 of the annular U-shaped support ring 35. The compensating ring 34 of the current embodiment is made from a resilient material. Some polymers are suitable for this purpose including some polymers, which are elastomers. One such elastomer is sold by E. I. duPont de Nemours under the trademark VITON. This elastomer has a coefficient of thermal expansion of about

120×10⁻⁶ in/in/degree F. Other resilient materials may be used as long as the coefficient of thermal expansion is greater than the coefficient of thermal expansion of the material used to manufacture the case 1 of the transmission device A.

A backing ring 36 is positioned between the compensating ring 34 and the shoulder 12 of the case 1. In the present embodiment, the backing ring 36 is made of steel. The backing ring 36 is sized to fit between the two flanges 40 of the annular U-shaped support ring 35 with the fit between the two flanges 40 being tight enough to allow the backing ring to remain between the two flanges to hold the compensating ring 34 in position, but loose enough to allow the backing ring to be pushed away from the annular U-shaped support ring 35 when the compensating ring 34 expands after being warmed to a higher temperature.

The compensating ring 34 maintains all of the bearings 8, 9, 17, and 18 that are along the two shafts 2 and 3 at a generally uniform setting over a wide range of temperature variations. Should the transmission device A experience an increase in temperature, its case 1 will expand more than the two shafts 2 and 3. However, because the coefficient of thermal expansion of the compensating ring 34 is greater than that of the case 1, the compensating ring 34 will maintain the spread between the two bearings 8 and 9, or 17 and 18, consistent with that of the expansion of the two axially aligned shafts 2 and 3. To this end, as the case 1 expands, thus moving apart the shoulders 12 and 15, or 33 and 35, which confine the cups 20 of the bearings 8 and 9, or 17 and 18, the compensating ring 34 likewise expands axially and forces the cup 20 for the bearings 8 and 17 farther from the shoulders 12 and 33. The distance that cup 20 for the bearing is displaced corresponds roughly to the difference in expansion between the case 1 and the two shafts 2 and 3 measured in the region between the two bearings 8 and 9, or 17 and 18, less any axial offset caused by axial expansion in the bearings.

Of course, when the transmission A experiences a decrease in its operating temperature, the opposite occurs. The compensating ring 34 will axially contract about the same as the difference between the contraction of the case 1 and two shafts 3 and 4, less the axial offset caused by contraction of the bearings so that the setting for the bearings remains essentially the same. Thus, the compensating ring 34 compensates for differential thermal expansions and contractions between the case 1 and the axially aligned shafts 2 and 3 that are within the case 1.

As a result of the thermal compensation provided by the compensating rings 34 of the two bearings 8 and 17, the bearings along the aligned shafts 3 and 4 do not experience excessive preload at cold temperatures. Additionally, the compensating rings 34 eliminate excessive end play in the bearings 8, 9, 17, and 18 at higher operating temperatures, and this causes a better distribution of loads within those bearings, extends their lives, and improves machine reliability. Also, the compensating rings 34 expand radially, although slightly, and this tends to prevent the cups 20 in which they are located from rotating in the bores 10, 14, 32, and 41 for the cups 20. The compensating rings 34 may also serve to dampen vibrations in the shafts 2 and 3, and this together with the reduction in end play may reduce the noise generated by the transmission device A.

It is understood that while the present embodiment of the invention shows only bearings 8 and 17 as having thermal compensating rings, in other embodiments the bearings for the input shaft 2 and the output shaft 3 may also have thermal compensating rings depending upon the specific application.

The length “l” of the compensating ring 34 depends on a number of factors including the distance (d_{c}) between the case shoulders 12 and 15, or 33 and 35, the distance (dₛ) between shaft shoulders 13, 16, or 31 and backing face 27, the coefficient (C_{Al}) of the thermal expansion for the aluminum alloy of the case 1, the coefficient (C_{St}) of thermal expansion for the steel of the shafts 2 or 3, the coefficient (Cₚ) of thermal expansion for the compensating ring 34, the temperature differential (AT), and the geometry of the bearings. To determine the length l, one first calculates the maximum setting change (MSC) that results from the maximum change in temperature from ambient. This calculation not only considers the differences between the expansion of the case 1 and the shafts 2 and 3, but also the offsetting difference in the stands of the bearings 8 and 9, or 17 and 18, which occur primarily as a result of radial and axial expansions within the bearings themselves. In this regard, the geometry of a single row tapered roller bearing is such that the radial and axial expansion resulting from an increase in temperature will enlarge the stand of the bearing, that is to say the bearing will experience an increase (b) in the distance between the back face 27 of its cone 19 and the back face 37 of its cup 20. Formulas familiar to bearing engineers exist for calculating the increase (b) in the stand of a tapered roller bearing.

The maximum setting change (MSC) is calculated using the following formula:
MSC=[d_{c}(C_{Al})−dₛ(Cₛₜ)](ΔT−εΔb)

where:
i. εΔb is the sum of the changes in the stands for the bearings 8 and
ii. 9, or 17 and 18 in the case 1 of the shafts 2 and 3.

The length l of the insert is derived from the following formula:

$$L = \frac{MSC}{( {C}_{p} ) ( Δ T )}$$

As an example, assume the bearings 8 and 9 on the steel input shaft 2 have the cup back faces 37 set 13.00 inches apart; that the distance between cone back faces 27 is 10.00 inches; that the ambient temperature is 70 degrees F.; that the normal operating temperature is 220 degrees F., and that the coefficient (Cₚ) of expansion for the compensating ring 34 is 120×10⁻⁶ in/in/degree F. Aluminum has a coefficient (C_{Al}) of expansion of 13×10⁻⁶ in/in/degree F., while the coefficient (C_{St}) for steel is 6.5×10⁻⁶ in/in/degree F. Also assume the sum of the changes (εΔb) in the stands of the two bearings 8 and 9 amounts to 0.005 inches. The maximum setting change (MSC) as the temperature of the transmission device A rises from 70 degrees F. to 220 degrees F. amounts to:
MSC└13(13×10⁻⁶)−10(6.5×10⁻⁶)┘(220−70)−0.005=0.011 in.

The compensating ring 34 must have a length l of:

$$l = \frac{0.011}{( 120 \times {10}^{- 6} ) 150} = 0.611 in .$$

It is appreciated that because the compensating ring 34 is confined radially as well as axially, and indeed retained in a state of axial compression when the transmission A is at ambient temperature, the volumetric expansion of the material in the compensating ring 34 is in effect converted into a linear expansion. In other words, the compensating ring 34, being confined both radially and circumferentially, experiences only axial expansion from an increase in temperature, and what may have otherwise occurred as radial and circumferential expansion, manifests itself as linear expansion. In short, the radial confinement produces a volumetric condition in which the coefficient of linear expansion is increased. In order to utilize the volumetric principle of compensation, the material of the insert should be somewhat flexible, and for this reason elastomers, such as the elastomer sold under the trademark VITON, are generally better suited than more rigid polymers.

Thus, when the length I of the compensating ring 34 for the forgoing example is calculated on a volumetric basis, it becomes:

$$l = \frac{0.011}{( 120 \times {10}^{- 6} ) 150} - \frac{1}{3} = \frac{0.611}{3} = 0.204 in .$$

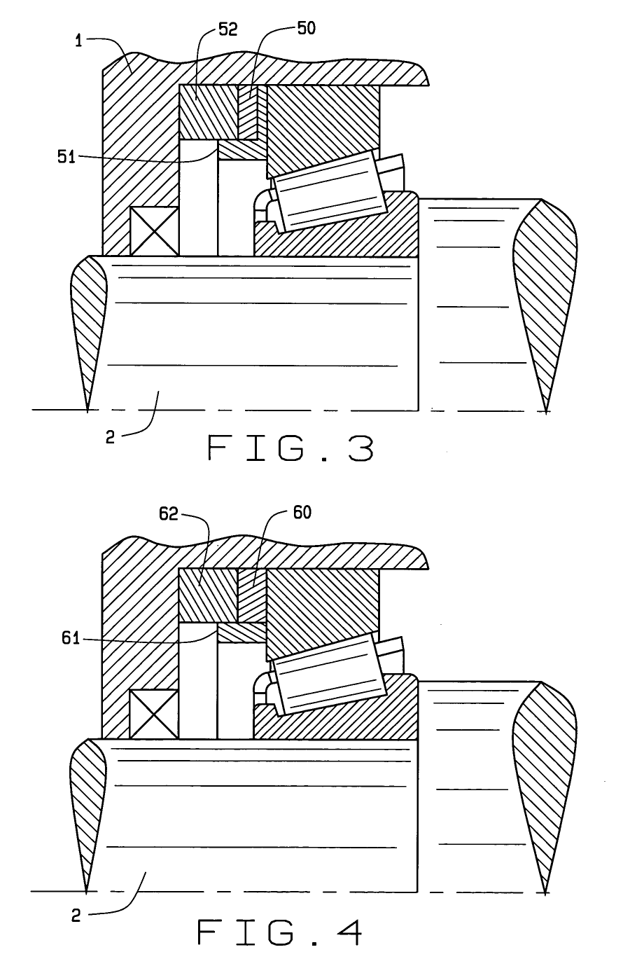

FIG. 3 shows another embodiment of the present invention A wherein the compensating ring 50 fits between and is captivated by an L-shaped support ring 51, a backing ring 52, and the case 1 of the transmission device A. The materials used and the operation of the compensating ring 50, L-shaped support ring 51, and the backing ring 52 are the same as described in the first embodiment above. Additionally, the above formulae may be used for this second embodiment.

FIG. 4 shows yet another embodiment of the present invention wherein the compensating ring 60 is held in place by a cylindrical support ring 61 and the backing ring 62. Again the materials used, the operation, and the necessary calculations for this third embodiment are the same as for the first embodiment.

It will be appreciated that the compensating ring in each of the above embodiments may have one surface attached to either the bearing cup, the backing ring, or the support ring. This attachment retains the compensating ring within the assembly to prevent repositioning of the compensating ring and to reduce the possibility of any wedging of the compensating ring between any of the bearing components. It is understood that the method by which the compensating ring is retained can be accomplished by using adhesives, chemical welding, threaded or non-threaded fasteners, or any other mechanical methods that would prevent the compensating ring from moving from its preferred position.

While the above description describes various embodiments of the present invention, it will be clear that the present invention may be otherwise easily adapted to fit any configuration where a bearing having thermal compensating capability is required.

As various changes could be made in the above constructions without departing from the scope of the invention, it is intended that all matter contained in the above description or shown in the accompanying drawings shall be interpreted as illustrative and not in a limiting sense.

What is claimed is:

1. In combination with a case having abutments, at least one shaft in the case, the at least one shaft also having abutments presented toward and spaced axially from the abutments of the case, the at least one shaft being formed from a material which has a different coefficient of thermal expansion than the material of the case, and at least two bearings supporting the at least one shaft in the case, with the bearings being configured to accommodate both axial and radial loads and being mounted in the case and on the at least one shaft between the abutments of the case and the at least one shaft where they are in opposition to each other, so that the bearings confine the at least one shaft both axially and radially in the case, the bearings having inner and outer races each of which is presented opposite to one of the abutments and is provided with a raceway that faces the raceway of the other race for the bearing, and rolling elements which roll along the raceways, the improvement comprising:
a support ring, a retaining ring, and a compensating ring located between the abutments of the case and the abutments of the at least one shaft such that the compensating ring responds to temperature changes in at least one of either the case, the bearing, or the shaft to thereby compensate for differential thermal expansion and contraction between the shaft and the case so that the bearings maintain a more uniform setting over a range of temperature variations.

2. The combination according to claim 1 wherein the compensating ring has a coefficient of thermal expansion substantially greater than both the case and the at least one shaft.

3. The combination according to claim 2 wherein the compensating ring is formed at least in part from a polymer.

4. The combination according to claim 2 wherein the compensating ring is formed at least in part from an elastomer.

5. The combination according to claim 2 wherein the compensating ring includes a flexible material that is rigidly and snugly confined radially by the support ring and the backing ring such that the compensating ring does not expand radially inwardly or outwardly, whereby volumeric expansion and contraction manifests itself only in the axial direction and is greater than that attributable to the coefficient of thermal expansion.

6. The combination according to claim 5 wherein the bearing is a tapered roller bearing having a cone provided with an outwardly presented raceway, a cup provided with an inwardly presented raceway, and tapered rollers located between the raceways of the cup and cone.

7. The combination according to claim 6 wherein the support ring has an annular U-shape having two flanges and a bottom and is located at a front face of the outer race of the bearing such that the bottom of the annular U-shaped support ring is against the front face of the outer race of the bearing.

8. The combination according to claim 7 wherein the backing ring is sized to fit between the two flanges of the annular U-shaped support ring with the fit between the two flanges being tight enough to allow the backing ring to remain between the two flanges to hold the compensating ring in position, but loose enough to allow the backing ring to be pushed away from the annular U-shaped support ring when the compensating ring expands after being warmed to a higher temperature.

9. The combination according to claim 2 wherein the compensating ring includes a flexible material that is rigidly and snugly confined radially by the support ring, the backing ring, and the case of the transmission device such that the compensating ring does not expand radially inwardly or outwardly, whereby volumeric expansion and contraction manifests itself only in the axial direction and is greater than that attributable to the coefficient of thermal expansion.

10. The combination according to claim 9 wherein the support ring is an L-shaped support ring having a vertical radial surface and a horizontal axial surface, the L-shaped support ring being located at a front face of the outer race of the bearing such that the vertical radial surface of the L-shaped support ring is against the front face of the outer race of the bearing.

11. The combination according to claim 10 wherein the backing ring is sized to fit between the horizontal axial surface of the L-shaped support ring and the case of the transmission device with the fit being tight enough to allow the backing ring to remain between the L-shaped support ring and the case of the transmission device to hold the compensating ring in position, but loose enough to allow the backing ring to be pushed away from the L-shaped support ring when the compensating ring expands after being warmed to a higher temperature.

12. The combination according to claim 9 wherein the support ring is a ring-shaped support ring having in inner diameter and an outer diameter.

13. The combination according to claim 12 wherein the backing ring is sized to fit between the outer diameter of the support ring and the case of the transmission device with the fit being tight enough to allow the backing ring to remain between the support ring and the case of the transmission device to hold the compensating ring in position, but loose enough to allow the backing ring to be pushed away from the support ring when the compensating ring expands after being warmed to a higher temperature.

14. A tapered roller bearing comprising:
a first race in the form of a cone having an outwardly presented tapered raceway and a back face located beyond the large end of the raceway;
a second race in the form of a cup that is located around the cone and has an inwardly presented raceway and a back face at the small end of the raceway wherein one of either the first race of the second race further includes a backing surface that is presented in the same direction as its back face;
tapered rollers located in a single row between the raceways of the cup and cone; and
a compensating ring substantially retained by a support ring and a backing ring wherein one of either the compensating ring, the support ring, or the backing ring is located against the backing surface of that race, the compensating ring being made formed from a material having a high coefficient of thermal expansion.

15. The tapered roller bearing according to claim 14 wherein the compensating ring is formed primarily from an elastomer having a high coefficient of thermal expansion.

16. The tapered roller bearing according to claim 14 wherein the compensating ring is made from a material having a high coefficient of thermal expansion.

17. The tapered roller bearing according to claim 14 wherein the compensating ring includes a flexible material that is rigidly and snugly confined radially by the support ring, the backing ring, and the case of the transmission device such that the compensating ring does not expand radially inwardly or outwardly, whereby volumeric expansion and contraction manifests itself only in the axial direction and is greater than that attributable to the coefficient of thermal expansion.

18. The tapered roller bearing according to claim 17 wherein the support ring has an annular U-shape having two flanges and a bottom and is located at a front face of the outer race of the bearing such that the bottom of the annular U-shaped support ring is against the front face of the outer race of the bearing.

19. The tapered roller bearing according to claim 18 wherein the backing ring is sized to fit between the two flanges of the annular U-shaped support ring with the fit between the two flanges being tight enough to allow the backing ring to remain between the two flanges to hold the compensating ring in position, but loose enough to allow the backing ring to be pushed away from the annular U-shaped support ring by the compensating ring when the compensating ring expands after being warmed to a higher temperature.

20. The tapered roller bearing according to claim 17 wherein the support ring is an L-shaped support ring having a vertical radial surface and a horizontal axial surface, the L-shaped support ring being located at a front face of the outer race of the bearing such that the vertical radial surface of the L-shaped support ring is against the front face of the outer race of the bearing.

21. The tapered roller bearing according to claim 20 wherein the backing ring is sized to fit between the horizontal axial surface of the L-shaped support ring and the case of the transmission device with the fit being tight enough to allow the backing ring to remain between the L-shaped support ring and the case of the transmission device to hold the compensating ring in position, but loose enough to allow the backing ring to be pushed away from the L-shaped support ring by the compensating ring when the compensating ring expands after being warmed to a higher temperature.

22. The tapered roller bearing according to claim 17 wherein the support ring is a ring-shaped support ring having in inner diameter and an outer diameter.

23. The tapered roller bearing according to claim 22 wherein the backing ring is sized to fit between the outer diameter of the support ring and the case of the transmission device with the fit being tight enough to allow the backing ring to remain between the support ring and the case of the transmission device to hold the compensating ring in position, but loose enough to allow the backing ring to be pushed away from the support ring by the compensating ring when the compensating ring expands after being warmed to a higher temperature.

24. In combination with a case having abutments, at least one shaft in the case, the at least one shaft also having abutments presented toward and spaced axially from the abutments of the case, the at least one shaft being formed from a material which has a different coefficient of thermal expansion than the material of the case, and at least two bearings supporting the at least one shaft in the case, with the bearings being configured to accommodate both axial and radial loads and being mounted in the case and on the at least one shaft between the abutments of the case and the at least one shaft where they are in opposition to each other, so that the bearings confine the at least one shaft both axially and radially in the case, the bearings having inner and outer races each of which is presented opposite to one of the abutments and is provided with a raceway that faces the raceway of the other race for the bearing, and rolling elements which roll along the raceways, the improvement comprising:
means for responding to temperature changes in at least one of either the case, the bearing, or the shaft to thereby compensate for differential thermal expansion and contraction between the shaft and the case so that the bearings maintain a more uniform setting over a range of temperature variations.
